(19) United States
(12) Patent Application Publication
(10) Pub. No.: US 2015/0276965 A1
(43) Pub. Date: Oct. 1, 2015

(54) METAL FOREIGN OBJECT DETECTION SYSTEM FOR INDUCTIVE POWER TRANSMISSION SYSTEMS

(71) Applicant: PAUL VAHLE GMBH & CO. KG, Kamen (DE)

(72) Inventor: Faical Turki, Bergkamen (DE)

(21) Appl. No.: 14/428,388

(22) PCT Filed: Sep. 16, 2013
(86) PCT No.: PCT/EP2013/069174

§ 371 Date: Mar. 16, 2015

(30) Foreign Application Priority Data
Sep. 17, 2012 (DE) 10 2012 108 671.0

(51) Int. Cl. G01V 3/10; H02J 17/00; H02J 5/00

(52) U.S. Cl. CPC G01V 3/101; H02J 5/005; H02J 17/00

(57) ABSTRACT

The invention relates to a detection system for detecting electrically conductive foreign objects (F) in the area (3) between the primary winding and secondary winding of an inductive power transmission system, wherein the detection system also has at least one primary coil (L_{A}) and at least one secondary coil (L_{B}) which are coupled together, and that at least one primary coil (L_{A}) and/or at least one secondary coil (L_{B}) of the detection system is an integral part of at least one electric resonant circuit (L_{A}-C_{A}; L_{B}-C_{B}), wherein an electric source (7) energises at least one resonant circuit (L_{A}-C_{A}), and that a monitoring device monitors at least one electric variable on the secondary side and/or on the primary side of the detection system and effects the foreign object detection by means of the measured electric variable.

### CROSS-REFERENCE TO RELATED APPLICATIONS

This application is a Section 371 U.S. National Stage Filing of International Application No. PCT/EP2013/069174, filed Sep. 16, 2013, which was published in the German language on Mar. 20, 2014, under International Publication No. WO 2014/041176 A2, which claims priority to German Patent Application No. 10 2012 108 671.0, filed on Sep. 17, 2012, the disclosures of which are incorporated herein by reference.

### BACKGROUND OF THE INVENTION

The present invention relates to a detection system for detecting electrically conductive foreign objects in the area between the primary winding and secondary winding of an inductive power transmission system.

Contactless power transmission uses high-frequency magnetic fields. If electrically conductive foreign objects reach the area of these magnetic fields, eddy currents are generated in them which result in the foreign objects heating up. Furthermore, hysteresis losses also occur with ferromagnetic materials, which likewise contribute to the heating of the foreign objects. In addition, losses in the power transmission arise due to the eddy currents.

The foreign objects can become ignited by the heating. If the foreign objects are living beings they are exposed to great danger as a result of the possible heating.

Consequently, electrically conductive foreign objects represent a disturbance factor, e.g. in the case of contactless charging of the battery of an electric vehicle. Therefore, it is necessary before each power transmission to make sure, by means of suitable measures, such as automatic or manual cleaning procedures, that foreign objects have been removed from the area of the high-frequency magnetic field of the power transmission system. Thus, e.g. the driver of a vehicle whose battery is to be inductively charged can be continually requested to remove any foreign objects before the charging process begins. In order to avoid unnecessary cleaning, it is therefore desirable if foreign objects can be automatically detected and only the actual presence of foreign objects generates a request to the driver to clean the power transmission system.

Numerous systems for detecting foreign objects are known. DE 102009033236 A1 discloses a system for detecting foreign objects, in which foreign objects are detected by means of an ultrasonic, radar, infrared or electronic image sensor. The sensors are preferably arranged on the secondary side, i.e. on the vehicle. The disadvantage with this is that the sensors are exposed to outside weather conditions and pollution and are consequently prone to faults and failure and additionally can be easily destroyed by a stone chip or external forces.

DE 102009033237 A1 discloses a system for detecting foreign objects, in which foreign objects are to be detected by means of a plurality of regularly arranged planar coils as measuring inductors. The inductors of all coils are monitored by means of an evaluation device and compared by means of a reference impedance or reference distribution. If there is a deviation of a predetermined extent, a signal is output which displays the deviation. The disadvantage with this system is that a plurality of inductors have to be monitored by means of suitable electronics. In addition, only the change in the inductor due to a foreign object is measured.

DE 69827733 T2 discloses a system for detecting foreign objects, in which two primary windings and two secondary windings are provided, wherein the two primary windings are connected to a common core but are arranged spatially separate from one another, so that each one generates an alternating magnetic field in a different spatial area. The secondary windings are arranged similarly to the primary windings, so that they face the primary windings during the charging process. Accounted for by the separately arranged primary windings, the oscillation circuits of the push-pull branches react independently of one another to unequal loads of the spatial regions of the alternating magnetic field. In conjunction with work values, with the system load types in the secondary part of the alternating magnetic field, such as full load, no load and improper load due to a foreign object, can be detected by the system and corresponding measures initiated. The disadvantage with this system is that the charging process always has to be begun in order to detect foreign objects.

DE 69834537 T2 discloses a system for contactless power transmission, in which on the primary side and secondary side in each case two separate windings are arranged, wherein in each case one winding is provided for the power transmission and one winding is provided for the signal transmission. The charging process can always only then take place if a corresponding signal is transmitted to the primary side via the signal transmission coils. This system only prevents foreign objects from being heated, provided that the consumer unit is not arranged upstream of the charging station. This system cannot detect any foreign objects if the consumer unit is arranged upstream of the primary side of the charging station.

A system for contactless power transmission is known from EP 2317625 A2, in which in order to detect foreign objects the current flow through the primary winding is measured and compared to a predetermined value, wherein in order to detect the foreign object the transmission frequency is increased and the load of the consumer unit is separated from the secondary resonant circuit. The disadvantage with this system is that the distance between the primary winding and the secondary winding is not always equal and hence the coupling factor is always different, so that different currents always arise in the primary circuit. In addition, the charging process always has to be interrupted in order to detect the foreign objects, which leads to more rapid wear and tear and ageing of the battery to be charged and of the used components. It is also a disadvantage that due to the size of the primary winding and the secondary winding foreign objects which are small in relation to them cannot be reliably detected.

### BRIEF SUMMARY OF THE INVENTION

The object of the present invention is to provide a detection system which also reliably detects small foreign objects.

This object of this invention is advantageously achieved by a system having the features of Claim 1. Advantageous embodiments of the system according to claim 1 result through the features of the sub-claims.

Depending on the material, non-ferromagnetic metals cause distortions in the magnetic field in the form of displacement with pure eddy-current effects. In contrast, ferromagnetic materials concentrate the magnetic field. These effects can be easily measured by determining the inductance of a winding. A corresponding system is, as described above, previously known from DE 102009033236 A1. However, the change in the inductance is, as a nile, too low to produce accurate switching thresholds.

The invention therefore provides a second coil which is also affected by the field distortion through the foreign object or bodies. The two used coils are magnetically coupled, wherein the coupling is altered by the foreign objects. This change can be detected by measuring an electric variable, such as e.g. the current flowing through a coil or through the induced voltage. In order to be able to detect the change in the coupling accurately, it is advantageous for the coupled coils to be an integral part of resonant circuits which have the same resonance frequency. Due to the high Q factor of the coupled resonant circuits, the change in the coupling is easy to detect through the changing reactive power. Thus, e.g. a signal can be fed into the first coil and the induced voltage measured in the second coil. As long as the system is in resonance, the induced voltage is very high. However, as soon as a foreign object is located in the area of the coils the two resonant circuits are no longer attuned due to the change in the inductances and the coupling between the coils changes, whereby the induced voltage sinks compared to the case of resonance. By providing the coupled resonant circuits, the change in the induced voltage is sufficiently large for the induced voltage to be able to be used to detect electrically conductive foreign objects with a threshold.

The detection system according to the invention can be accommodated as an independent system in its own housing which e.g. can be placed on the primary winding of an inductive power transmission system or can be attached to it. However, it is equally possible for the two coils, which can preferably be formed as flat coils, and optionally also the associated evaluation electronics along with the circuit of the coils to be arranged in the primary-side or secondary-side housing of the inductive power transmission system.

The primary coil and secondary coil of the detection system preferably cover the active area of the inductive power transmission system. In particular, they can at least have the size and form of the primary winding or of the secondary winding of the power transmission system, depending on whether they are arranged near the primary winding or the secondary winding of the inductive power transmission system. However, the coils with respect to their covered area can also be formed larger than the windings of the power transmission system, so that they protrude laterally beyond them.

In order to detect the smallest possible foreign objects by means of the detection system, the coils are formed in such a way that through the magnetic field of the transmission device no or in relation to the voltage of the source a small electric voltage is induced in the primary coil and the secondary coil of the detection system. For this purpose, the coils are advantageously formed in a meandering pattern, so that the voltages induced in the individual conductor sections of the coils due to the magnetic field of the power transmission cancel one another out. To this end, each coil of the detection system can be formed by a plurality of straight conductor sections which in each case are arranged parallel in relation to one another and in series, wherein, at the same time, the straight conductor sections of the primary and secondary coils are arranged parallel, at an angle of 45° or perpendicularly in relation to one another.

The length of the straight conductor sections can be advantageously dimensioned in such a way that the conductor sections extend over the primary arrangement or secondary arrangement, in particular their windings, of the power transmission system.

The distance between the adjacent straight conductor sections of each coil which are arranged parallel in relation to one another is adapted to the size of the smallest foreign objects to be detected. The distance, depending on the foreign objects to be detected, can be 1 to 10 cm, particularly preferably 2.5 to 8 cm.

In one particularly preferred embodiment of the detection system, the primary resonant circuit is formed by the primary coil and a capacitor which in particular are connected in series. The secondary resonant circuit is formed by the secondary coil and a capacitor which are connected in parallel or in series, wherein the source is an AC voltage source or an AC power supply, to which the primary resonant circuit is connected. A rectifier rectifies the secondary-side output voltage of the secondary-side resonant circuit and smooths it by means of a capacitor. A monitoring device compares the output voltage of the rectifier to a voltage value stored in a memory. If the measured output voltage falls under a certain threshold value, a signal is generated which signifies a detected foreign object.

The monitoring device can advantageously be formed by a microcontroller which forms the source, in particular with a PWM output, and which with an analogue-to-digital converter input detects the output voltage of the rectifier.

Advantageously, the coils of the detection system are formed by conducting paths of a circuit board, whereby they can be manufactured easily and cost-effectively. Thus, e.g. a double-sided laminated printed circuit board can be used, which forms a coil on each of its two sides. In addition, further electric components can be arranged on the circuit board, so that a small and compact structure results.

The detection system can calibrate itself at intervals, in which the frequency of the source during the calibration process is varied until the resonance frequency at which the maximum reactive power of the resonant circuit arrangement occurs is detected.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

The invention is explained in more detail below with the aid of drawings.

FIG. 1: shows a block circuit diagram of the detection system according to the invention;

FIG. 2: shows a first possible design of the coils of the detection system;

FIG. 3: shows a second possible design of the coils of the detection system;

FIG. 4: shows a third possible design of the coils of the detection system;

FIG. 5: shows a possible electric circuit arrangement of the detection system and

FIG. 6: shows an equivalent circuit diagram for determining the electric components of the resonant circuits.

### DETAILED DESCRIPTION OF THE INVENTION

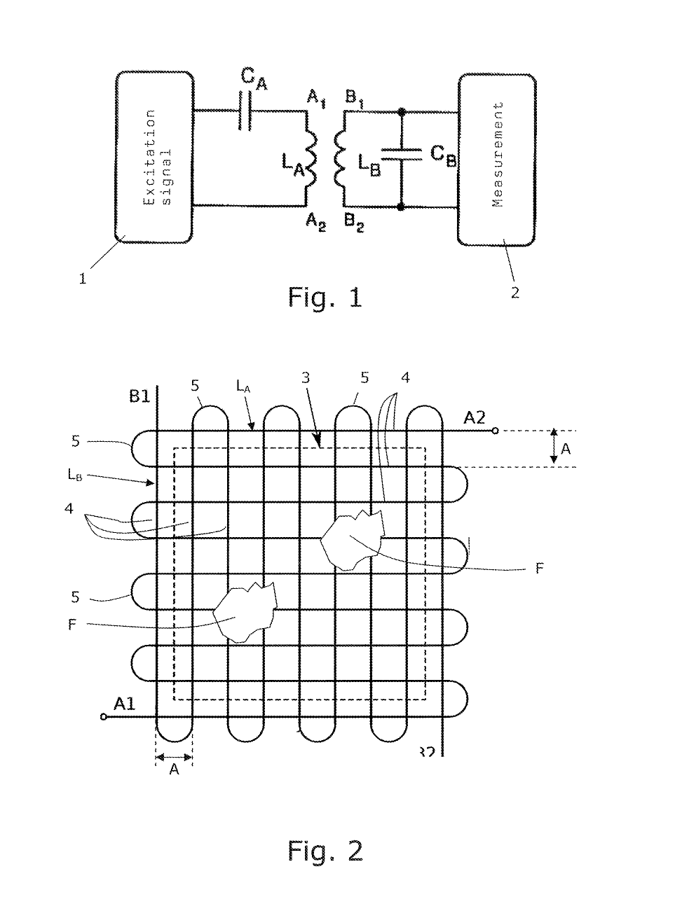

FIG. 1 shows a block circuit diagram of the detection system according to the invention. The detection system has a primary resonant circuit which is formed by the series connection of the capacitor C_{A} and the inductor L_{A} of the primary-side coil. The primary-side resonant circuit C_{A}-L_{A} is energised into oscillation by an excitation signal, wherein the excitation signal itself is generated from a source 1. The secondary-side parallel resonant circuit is formed by the capacitor C_{B} and the inductor L_{B} of the secondary-side coil. The voltage induced in the secondary-side resonant circuit is measured by means of the measuring device 2. The points A₁, A₂, B₁, B₂ are the connecting points of the inductors L_{A}, L_{B} or the coils of the detection system.

FIG. 2 shows a first possible design of the coils L_{A} and L_{B} of the detection system. The individual conductor sections of the coils L_{A} and L_{B} have straight conductor sections 4 which are arranged parallel in relation to one another and in series and are electroconductively connected together at their ends by the semi-circular connection sections 5. It can also be said that the conductors of the coils L_{A} and L_{B} are disposed in a meandering pattern. The coils L_{A} and L_{B} can e.g. be formed by conductors of a circuit board. Both coils L_{A} and L_{B} advantageously cover the area 3 of the contactless power transmission. It is advantageous if the coils L_{A} and L_{B} protrude beyond the edge of the area 3 which in particular can be formed by the primary or secondary coil of the power transmission system. The straight sections 4 of the coils L_{A} and L_{B} are arranged perpendicularly in relation to one another in the arrangement according to FIG. 2. The distance A between the straight conductor sections 4 determines the sensitivity of the detection system. The smaller the distance A is, the smaller the foreign objects are which can be detected by the detection system. The arrangement according to FIG. 2 having simply disposed conductors has the disadvantage that the coil terminals A₁, A₂, B₁ and B₂ are far apart from one another, whereby long connection lines are required to connect the coils L_{A} and L_{B}, whereby the main field of the power transmission could possibly couple with the connection lines.

The detection system uses coils L_{A} and L_{B} which are arranged separate from the windings of the power transmission system 3.

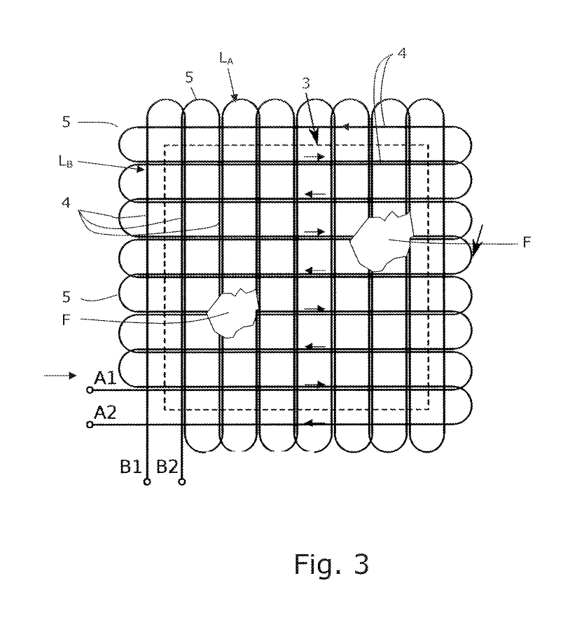

FIG. 3 shows a second possible design of the coils L_{A} and L_{B} of the detection system, in which the straight conductors are doubly disposed, so that the coil terminals A₁, A₂, B₁ and B₂ lie close together and hence no long additional connection lines are necessary and the magnetic main field has no adverse effects on the detection system. With this arrangement of the coils L_{A} and L_{B}, their straight conductor sections 4 are also arranged perpendicularly in relation to one another.

The coils L_{A} and L_{B} can be put onto circuit boards, since the current required through the coils L_{A} and L_{B} to measure the foreign objects F is small. It is also appropriate to arrange the electronics in the form of a signal generator for feeding-in and a measuring circuit on the same circuit board.

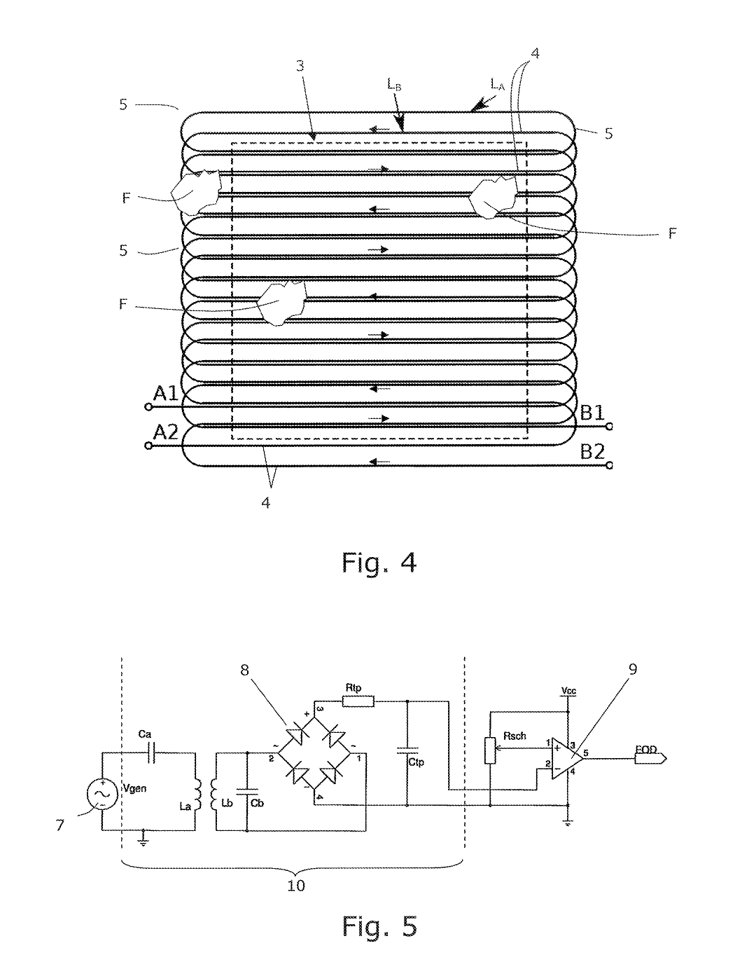

FIG. 4 shows a third possible design of the coils L_{A} and L_{B} of the detection system, in which the straight conductor sections 4 of the coils L_{A} and L_{B} are arranged parallel in relation to one another. The arrows specify the possible current flow direction during a particular moment in the coil L_{B}.

FIG. 5 shows a possible electric circuit arrangement for the detection system. A signal generator 7 is used for feeding the primary resonant circuit C_{A}-L_{A} and generates the AC voltage V_{gen} with a resonance frequency fᵣₑₛ of the resonant circuit. Theoretically, a square-wave signal would be sufficient, since only the fundamental harmonic is required from the resonant circuit. However, for reasons of electromagnetic compatibility (EMC), the use of a sine wave generator is recommended. The greater its signal amplitude is, the more precisely the measurement can be made, wherein, however, a compromise has to be made with the electromagnetic interference.

The parallel resonant circuit L_{B}-C_{B} is arranged on the secondary side. The voltage induced in the coil L_{B} is rectified and smoothed by means of the rectifier 8 and the smoothing capacitor Cₜₚ. The rectified voltage is compared by means of a comparator 9 to a reference voltage which through the voltage divider at R_{sch} is applied at input 1 of the comparator, wherein the output 5 of the comparator outputs the signal FOD (Foreign Object Detection) to a signalling and/or control device which is connected downstream and is not illustrated. If the smoothed voltage is smaller than the reference voltage, then this is interpreted to the effect that at least one foreign object is located in the active power transmission area. If the smoothed voltage is above or the same as the reference voltage, then this is interpreted to the effect that no foreign body is located in the system. It is possible that only the components in the area 10 are arranged on a circuit board.

The detection system can also continuously detect foreign objects during the power transmission, so that the power transmission does not have to be interrupted in order to detect foreign objects.

In addition, the detection system can be periodically calibrated by adapting the reference voltage to the respective conditions. This can take place automatically at specific intervals.

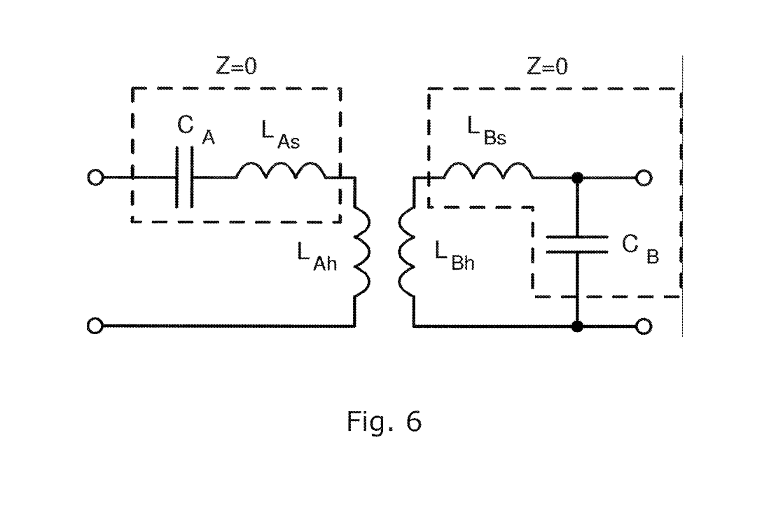

FIG. 6 shows an equivalent circuit diagram for determining the electric components of the primary-side resonant circuit and the secondary-side resonant circuit. The resonance of the primary series resonant circuit shown in FIG. 5 with the secondary-side parallel resonant circuit can be effected by means of the components L_{A}, C_{A}, L_{B} and C_{B}, e.g. by balancing between the capacitor C_{A} or C_{B} and the leakage inductance of L_{A} or L_{B}. The coupled resonant circuits can be represented by the equivalent circuit diagram shown in FIG. 6, wherein the coils L_{A} and L_{B} are represented by the two leakage inductances L_{As} and L_{Bs} and the mutual inductances L_{Ah} and L_{Bh}. At least one of these three inductances must be an integral part of a resonance circuit. If the resonance circuits are formed by the components C_{A}-L_{As} and L_{Bs}-C_{B}, then the resonance frequency fᵣₑₛ is calculated with the condition Z=0 by means of the following equation:

$${f}_{res} = \frac{1}{2 π \sqrt{{L}_{{A}_{s}} \times {C}_{A}}} = \frac{1}{2 π \sqrt{{L}_{{B}_{s}} \times {C}_{B}}}$$

The balancing can therefore be effected in such a way that only a part of each coil L_{A}, L_{B} is an integral part of a resonant circuit.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1-19. (canceled)

20. A detection system for detecting electrically conductive foreign objects in an area between a primary winding and a secondary winding of an inductive power transmission system, wherein the detection system includes:
at least one primary coil and at least one secondary coil which are coupled together, and wherein at least one primary coil and/or at least one secondary coil of the detection system is an integral part of at least one electric resonant circuit, wherein an electric source is configured to energize at least one resonant circuit, and
a monitoring device configured to monitor at least one electric variable on the secondary side and/or on the primary side of the detection system and to perform foreign object detection based at least in part on the measured electric variable.

21. The detection system according to claim 20, wherein the electric variable is a current and/or a voltage.

22. The detection system according to claim 20, wherein the primary coil and the secondary coil of the detection system are integral parts of electric resonant circuits that both have a same resonance frequency.

23. The detection system according to claim 20, further including an AC source configured to feed the primary coil or a primary resonant circuit including the primary coil, and wherein the secondary coil of the detection system is an integral part of an electric resonant circuit, wherein a frequency of the AC source is equal to a resonance frequency of the electric resonant circuit.

24. The detection system according to claim 20, wherein a resonance frequency of the coupled primary and/or secondary coils of the detection system is different from a fundamental frequency and frequencies of upper harmonics of the power transmission system.

25. The detection system according to claim 20, wherein the primary and secondary coils of the detection system are flat coils which are formed by a circuit board.

26. The detection system according to claim 20, wherein the primary and secondary coils of the detection system cover the area between the primary winding and the secondary winding of the inductive power transmission system, having at least the size and form of the primary winding of the power transmission system or protruding laterally beyond the primary winding of the power transmission system.

27. The detection system according to claim 20, wherein the coils of the detection system are formed in a meandering pattern such that, through the magnetic field of the transmission device, no electric voltage or a small electric voltage, relative to the voltage of the electric source, is induced in the primary coil and the secondary coil of the detection system.

28. The detection system according to claim 20, wherein the primary and secondary coils of the detection system are, respectively, formed by a plurality of straight conductor sections arranged physically parallel in relation to one another and electrically connected in series, and wherein the straight conductor sections of the primary and secondary coils are arranged parallel or at an angle between 0 and 90° in relation to one another.

29. The detection system according to claim 28, wherein a length of the straight conductor sections is dimensioned in such a way that the conductor sections extend over the primary arrangement or secondary arrangement of the power transmission system.

30. The detection system according to claim 28, wherein a distance between the adjacent straight conductor sections arranged physically parallel in relation to one another is adapted to a size of a smallest foreign object to be detected.

31. The detection system according to claim 28, wherein a distance between the adjacent straight conductor sections arranged physically parallel in relation to one another is 1 to 10 cm.

32. The detection system according to claim 20, wherein the primary and secondary coils of the detection system are arranged in a housing which is flat or are arranged in a housing together with the primary winding or the secondary winding of the power transmission system.

33. The detection system according to claim 20, wherein a primary resonant circuit is formed by the primary coil of the detection system and a capacitor connected in series, and wherein a secondary resonant circuit is formed by the secondary coil of the detection system and a capacitor that are connected in parallel, and wherein the electric source is an AC voltage source or an AC power supply, to which the primary resonant circuit is connected.

34. The detection system according to claim 33, further comprising a rectifier configured to rectify a secondary-side output voltage of the secondary resonant circuit, wherein the rectifier includes a capacitor configured to smooth the secondary-side output voltage, wherein the monitoring device is configured to detect an output voltage of the rectifier and to compare it to a voltage value stored in a memory or to a reference voltage.

35. The detection system according to claim 34, wherein the monitoring device includes a microcontroller that implements the electric source and has a pulse-width modulation (PWM) output, and which, along with an analog-to-digital converter input, is configured to detect the output voltage of the rectifier.

36. The detection system according to claim 20, further comprising an output unit configured to produce a visual signal, an acoustic signal, or both, if one or a plurality of foreign objects have been detected.

37. The detection system according to claim 20, wherein the detection system is configured to calibrate itself at intervals, wherein the frequency of the source is varied until a frequency at which a maximum reactive power of the at least one resonant circuit occurs is detected.

38. An inductive power transmission system having a detection system according to claim 20.

39. The detection system according to claim 24, wherein the resonance frequency of the coupled primary and/or secondary coils of the detection system is greater than the fundamental frequency of the power transmission system and lies between the 5^{th} and 7^{th} or between the 7^{th} and 9^{th} upper harmonics of the power transmission system
